(19) United States
(12) Patent Application Publication
(10) Pub. No.: US 2007/0136751 A1
(43) Pub. Date: Jun. 14, 2007

(54) Television receiver apparatus and method for automatically performing an action based on viewership information

(75) Inventors: Zachary Adam Garbow, Rochester, MN (US); Kevin Glynn Paterson, San Antonio, TX (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/297,309

(22) Filed: Dec. 8, 2005

(51) Int. Cl. H04N 5/445; G06F 3/00; G06F 13/00; H04N 7/025; H04N 7/10

(52) U.S. Cl. 725/46; 725/45; 725/34

(57) ABSTRACT

A television receiver apparatus and method is disclosed that allow a viewer to define a viewer profile, to receive and process viewership information received from the program provider, and to perform at least one action based on the viewer profile and the received viewership information. The viewer profile may include geographical preferences, genre preferences, and channel preferences. The at least one action may include determining the most popular transfer channels, and performing one or more of the following: 1) displaying the most popular transfer channel as picture-in-picture (PIP); 2) display a menu option to jump to the most popular transfer channel; 3) display a menu option of the top X most popular transfer channels. The at least one action may also include providing control signals to a digital video recorder (DVR) to start and/or stop recording based on the viewership information and the viewer profile.

### BACKGROUND OF THE INVENTION

1. Technical Field

This invention generally relates to television receivers, and more specifically relates to television receivers that provide two-way communication with the television program provider.

2. Background Art

Cable and satellite television systems provide a large number of channels that provide a wide variety of different programming to subscribers. These systems typically provide an on-screen program guide that allows a user to view what programs are currently playing and will be playing in the near future. On-screen program guides typically provide a display of several channels at the same time. However, with modem cable and satellite television systems that include hundreds of channels, scrolling through hundreds of channels on the on-screen program guide to determine which channel may be of interest is time-consuming and inefficient.

One way to enhance the presentation of program information in an on-screen program guide is disclosed in U.S. Patent Application Publication US 2003/0115585 A1, which discloses an enhanced electronic program guide that includes viewership information. By including viewership information, a viewer may visually determine from examining the on-screen program guide which shows are currently being watched by other subscribers. The viewership information allows the viewer to make a more informed choice regarding which program to watch. For example, the viewer can determine which programs are currently being watched by a relatively high number of subscribers, which allows the user to manually select a program that has high viewership.

While presenting viewership information in the on-screen program guide is helpful, the user must still manually navigate through hundreds of channels to view the viewership information associated with each channel. Without a way to use viewership information to automate tasks to enhance the viewer's viewing experience, known cable and satellite receivers will continue to suffer from inefficient ways of viewing and using viewership information.

### DISCLOSURE OF INVENTION

According to the preferred embodiments, a television receiver apparatus and method allow a viewer to define a viewer profile, to receive and process viewership information received from the program provider, and to perform at least one action based on the defined viewer profile and the received viewership information. The viewer profile may include geographical preferences, genre preferences, and channel preferences. The at least one action may include determining the most popular transfer channels, and performing one or more of the following: 1) displaying the most popular transfer channel as picture-in-picture (PIP); 2) display a menu option to jump to the most popular transfer channel; 3) display a menu option of the top X most popular transfer channels. The at least one action may also include providing control signals to a digital video recorder (DVR) that cause the DVR to record the most popular transfer channel. The at least one action may also include signaling to a DVR to stop recording when a specified percentage of viewers leave the current channel, thereby allowing a DVR to automatically extend the recording of a live program, such as a football game that goes into overtime, beyond the expected end time. The at least one action may also include signaling to a DVR to switch to the most popular transfer channel and to record the program on the most popular transfer channel. This can continue to allow a DVR to automatically record many programs that are the most popular based on the collected viewership information and the viewer profile. Note that the viewership information may be weighted according to the viewer profile, or according to recent viewer activity.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a television provider, networks and receivers in accordance with the preferred embodiments;

FIG. 2 is a block diagram of a television receiver in accordance with the preferred embodiments;

FIG. 3 is a flow diagram of a prior art method for collecting and displaying viewership information;

FIG. 4 is a flow diagram of a method in accordance with the preferred embodiments;

FIG. 5 is a flow diagram of one possible implementation of step 410 in FIG. 4;

FIG. 6 is a diagram showing a viewer profile window in a user interface that allows a user to make selections that define a viewer profile;

FIG. 7 is a flow diagram showing a first specific implementation of step 430 in FIG. 4 in accordance with the preferred embodiments;

FIG. 8 is a flow diagram showing a second specific implementation of step 430 in FIG. 4 in accordance with the preferred embodiments;

FIG. 9 is a flow diagram showing a third specific implementation of step 430 in FIG. 4 in accordance with the preferred embodiments;

FIG. 10 is a flow diagram showing a fourth specific implementation of step 430 in FIG. 4 in accordance with the preferred embodiments;

FIG. 11 is a flow diagram showing a fifth specific implementation of step 430 in FIG. 4 in accordance with the preferred embodiments;

FIG. 12 is a flow diagram showing a sixth specific implementation of step 430 in FIG. 4 in accordance with the preferred embodiments; and

FIG. 13 is a flow diagram showing steps that may be performed by the television receiver of FIG. 2 to weight the viewership information received from the provider.

### BEST MODE FOR CARRYING OUT THE INVENTION

The preferred embodiments provide a way to process viewership information collected by a television program provider according to a viewer profile defined by the viewer to enable one or more automatic actions in a television receiver. The viewer profile may include geographic preferences, genre preferences, and channel preferences. The automatic actions may include displaying the most popular transfer channel as picture-in-picture (PIP); displaying a menu option to jump to the most popular transfer channel; displaying a menu that includes a list of the top X most popular transfer channels; initializing the recording of the most popular transfer channel; stopping the recording of a program when a specified percentage of viewers leave the channel; and automatically recording a next program on the most popular transfer channel.

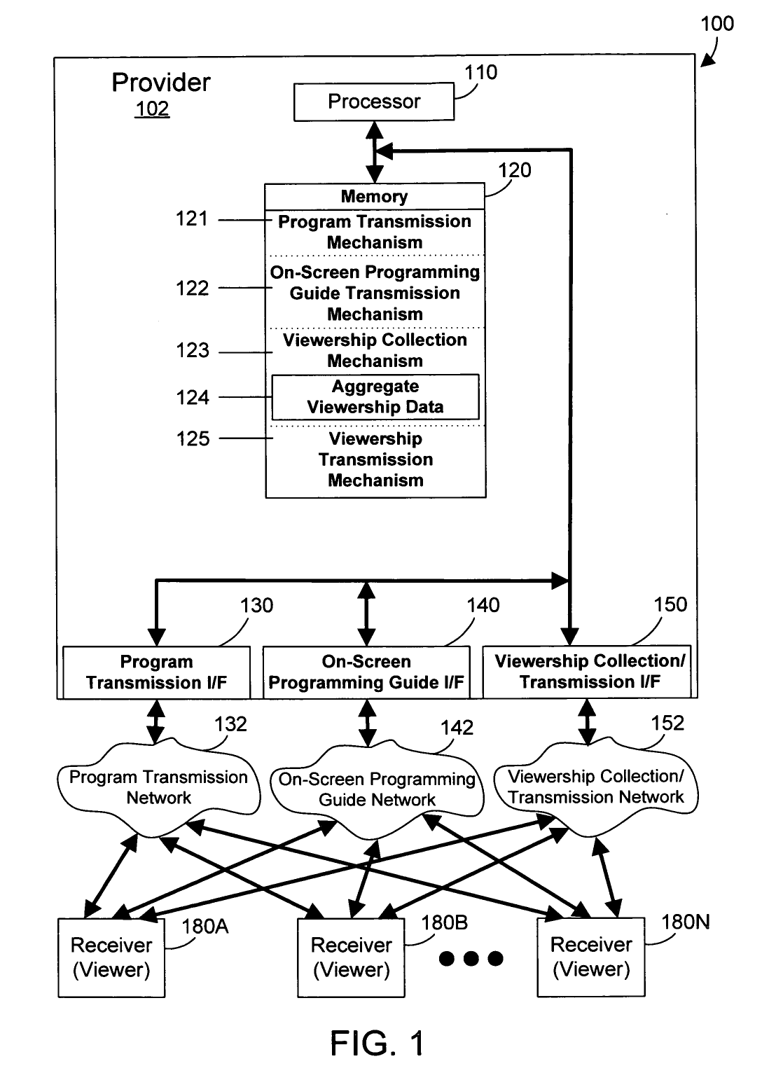

Referring to FIG. 1, a television system 100 in accordance with the preferred embodiments comprises a provider 102 coupled to receivers 180 (shown in FIG. 1 as 180A, 180B, . . . , 180N) via one or more communication networks (shown in FIG. 1 as networks 132, 142 and 152). Provider 102 comprises a processor 110 coupled to a Memory 120, and coupled to a program transmission interface 130, an on-screen programming guide interface 140, and a viewership collection/transmission interface 150. Memory 120 preferably includes a program transmission mechanism 121, an on-screen programming guide transmission mechanism 122, a viewership collection mechanism 123, and a viewership transmission mechanism 125. The program transmission mechanism 121 transmits television programs via the program transmission interface 130. The on-screen programming guide transmission mechanism 122 transmits information for an on-screen programming guide to receivers 180 via the on-screen programming guide interface 140. The viewership collection mechanism 123 collects viewership information from many receivers, and preferably aggregates this viewership information into aggregate viewership data 124. By aggregating the viewership information into the aggregate viewership data 124, the anonymity of each viewer is preserved, because only the statistical view across many viewers is presented. The aggregate viewership data 124 may include which channels are currently being watched by each receiver, as well as recent historical data that indicates which channels were previously watched by each receiver. The viewership transmission mechanism 125 transmits the aggregate viewership data 124 to receivers 180 via the viewership collection/transmission interface 150.

The program transmission interface 130 in the provider 102 is coupled to a program transmission network 132, which is, in turn, coupled to each receiver 180. In similar fashion, the on-screen programming guide interface 140 is coupled to an on-screen programming guide network 142, which is coupled to each receiver, and the viewership collection/transmission interface 150 is coupled to a viewership collection/transmission network 152, which is coupled to each receiver. While FIG. 1 shows these networks 132, 142 and 152 as separate, one skilled in the art will realize that two or three of these networks may be combined within the scope of the preferred embodiments. In addition, any or all of these networks 132, 142, and 152 may be implemented using hardwire or wireless communications, and may include a cable or satellite transmission system, a telephone line, or the Internet.

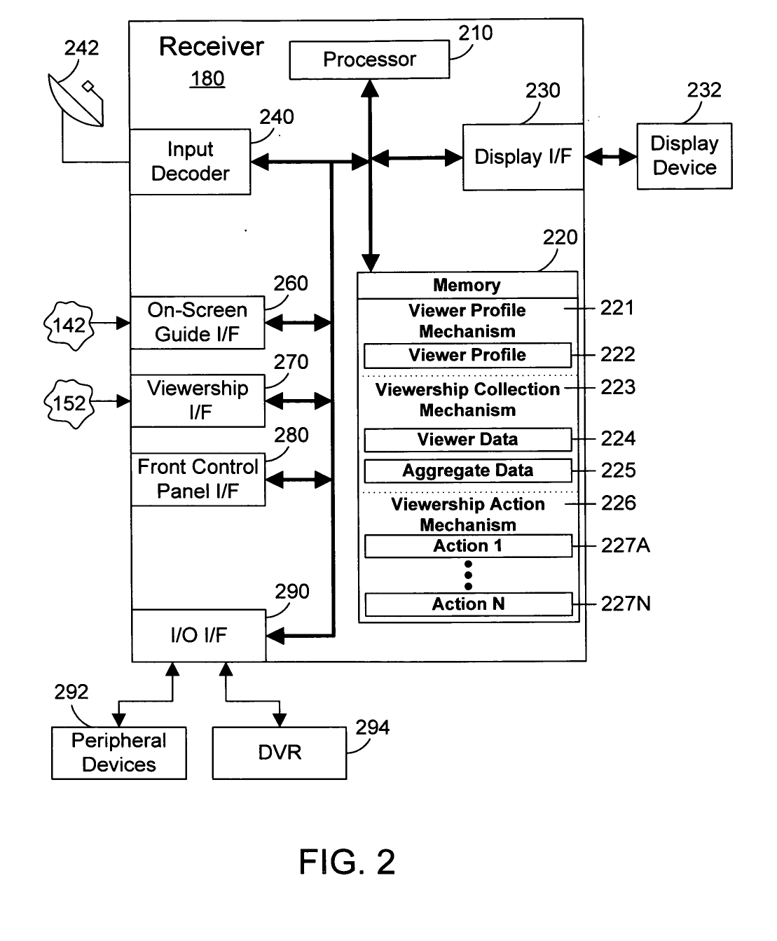

We now turn to the details of a receiver 180 in accordance with the preferred embodiments as shown in FIG. 2. Receiver 180 includes a processor 210 coupled via a system bus to a memory 220, a display interface 230, an input decoder 240, an on-screen guide interface 260, a viewership interface 270, a front control panel interface 280, and an input/output (I/O) interface 290. Processor 210 may be constructed from one or more microprocessors and/or integrated circuits. The display interface 230 is coupled to a suitable display device 232, such as a television screen. The input decoder 240 receives the program transmission information from the program transmission network (132 in FIG. 1). We assume for this specific example that the program transmission network is a satellite network, with input decoder 240 coupled to a satellite dish 242 which is coupled via wireless transmission to a satellite that is part of the program transmission network 132. Note that input decoder 240 could also be coupled via hardwire connection to a cable transmission network, or to any other suitable source of television programming via any suitable connection mechanism.

The on-screen guide interface 260 in receiver 180 is coupled to the on-screen programming guide network 142, shown in more detail in FIG. 1. Similarly, the viewership interface 270 is coupled to the viewership collection/transmission network 152, also shown in more detail in FIG. 1. The front control panel interface 280 provides an interface for knobs and/or buttons on the front control panel of receiver 180 that allow the user to perform functions via the front control panel. The I/O interface 290 may be coupled to one or more peripheral devices 292, such as a keyboard, mouse, joystick, light pen, touch-screen, speech recognition unit, or other peripheral device. In addition, the I/O interface 290 provides a way to output control signals, such as signals that start and stop recording of a digital video recorder (DVR) 294.

Memory 220 is any suitable type of memory, whether currently known or developed in the future, and expressly includes dynamic random access memory (DRAM), static random access memory (SRAM), magnetic or optical disks, etc. Memory 220 includes a viewer profile mechanism 221, a viewership collection mechanism 223, and a viewership action mechanism 226. The viewer profile mechanism 221 provides a graphical user interface, preferably via the display interface 230 and display device 232 that allows the user to define a viewer profile 222. The term “viewer profile” is used broadly herein to mean any suitable parameter that may be set or defined by a user. The viewership collection mechanism 223 preferably includes viewer data 224 and aggregate data 225. The viewer data 224 comprises the viewership data for this particular receiver 180, and is preferably transmitted via the viewership interface 270 and the viewership collection/transmission network 152 to the provider 102 (shown in FIG. 1). The aggregate data 225 represents aggregate viewership data that is transmitted by the provider 102 via the viewership collection/transmission network 152 to the receiver 180. This aggregate data may be in any suitable format, including current data for all channels, current data for a subset of channels, recent past historical data for all channels, recent past historical data for a subset of channels, etc.

The viewership action mechanism 226 performs one or more actions, represented in FIG. 2 as action 1 (227A), . . . , action N (227N), based on the results of processing the aggregate data 225 and the viewer profile 222. The actions performed by the viewership action mechanism 226 may include identifying a most popular transfer channel, and performing one or more of the following steps: 1) displaying the most popular transfer channel as picture-in-picture (PIP); 2) displaying a menu option to jump to the most popular transfer channel; and 3) initializing recording of the most popular transfer channel. The actions performed by the viewership action mechanism 226 may also include identifying the top X transfer channels, and displaying a menu of the top X transfer channels to a user, where X is any suitable number that may be configured by the receiver or that may be configured by the user in the viewer profile 222. The actions performed by the viewership action mechanism 226 may also include suitable outputs via I/O interface 290 that control the function of a digital video recorder 294. For example, the actions could include initializing DVR recording of a most popular transfer channel, whether or not the user actually goes to that channel. This allows the user to watch a channel, with the DVR automatically recording a program on a different channel that is the most popular transfer channel. In another example, the actions could include stopping DVR recording when a specified percentage of viewers leave the channel after the expected end of the program has already passed. In yet another example, the actions could include automatically recording a next program on a most popular transfer channel. This allows the user to automatically use the DVR to record a string of programs that depend upon the viewership information and that depend upon the viewer profile 222 defined by the user. Of course, the viewership information may be weighted using any suitable factor or heuristic. For example the viewership information could be weighted to provide more weight on users that match the viewer profile. In another example, the viewership information could be weighted to provide more weight on users whose recent viewing selections or patterns match the viewer's recent viewing selections or patterns, as indicated in the viewer data 224.

At this point, it is important to note that while the present invention has been and will continue to be described in the context of a fully functional television receiver, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links. Note that the preferred signal bearing media is tangible.

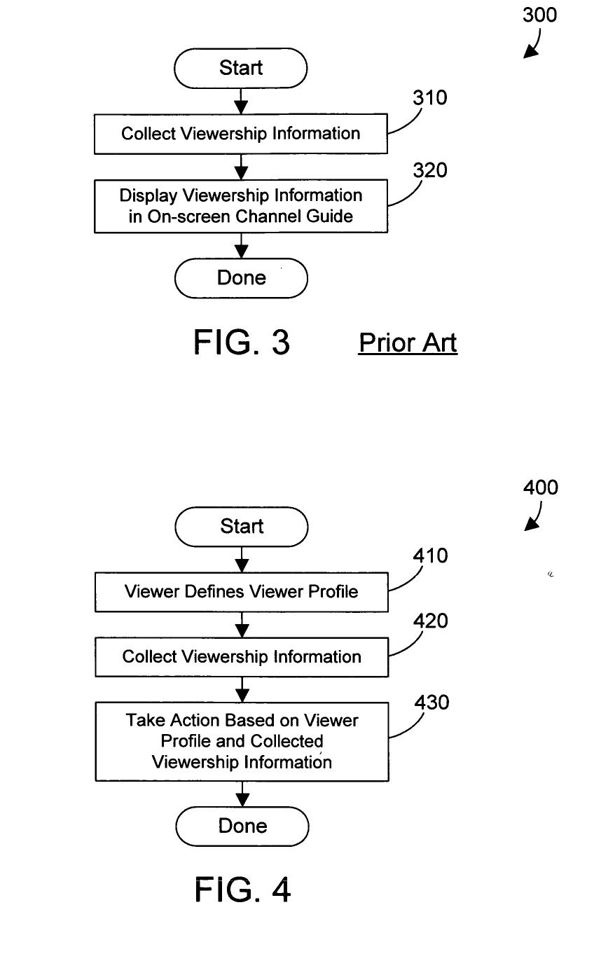

The prior art in U.S. Patent Application Publication US 2003/0115585 A1 shows a way to display viewership information directly on an electronic program guide. Method 300 in FIG. 3 is representative of the prior art method disclosed in the above-referenced patent application publication. First, viewership information is collected by the provider and transmitted where it is collected by the receiver (step 310). The viewership information is then displayed in the on-screen program guide (step 320). The only use of the viewership information disclosed in the above-referenced patent application publication is the display of the viewership information to the user in the on-screen program guide. Nowhere does the above-referenced patent application publication disclose taking any action based on the viewership information other than the display of the information in the on-screen program guide.

Referring to FIG. 4, a method 400 in accordance with the preferred embodiments allows a user to define a viewer profile (step 410). The viewership information is collected by the provider and transmitted where it is collected by the receiver (step 420).

The receiver may then process the viewership information in light of the viewer profile, and may take one or more actions based on the viewer profile and the collected viewership information (step 430). The defining of the viewer profile in step 410 and the automatic taking of one or more actions based on the viewer profile and the collected viewership information in step 430 are not taught or suggested in the above-referenced patent application, and therefore distinguish over the mere display of the viewership information.

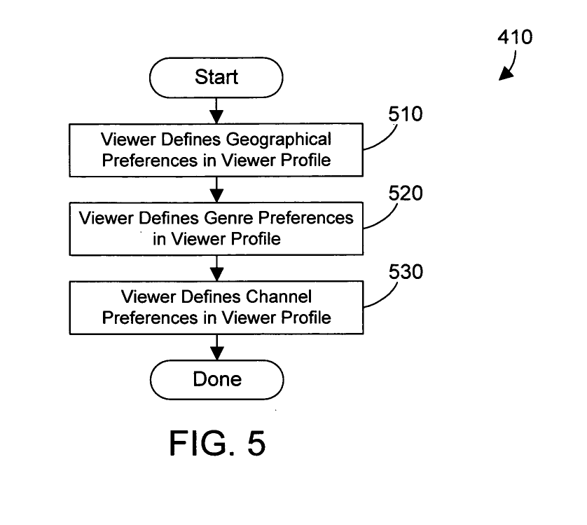

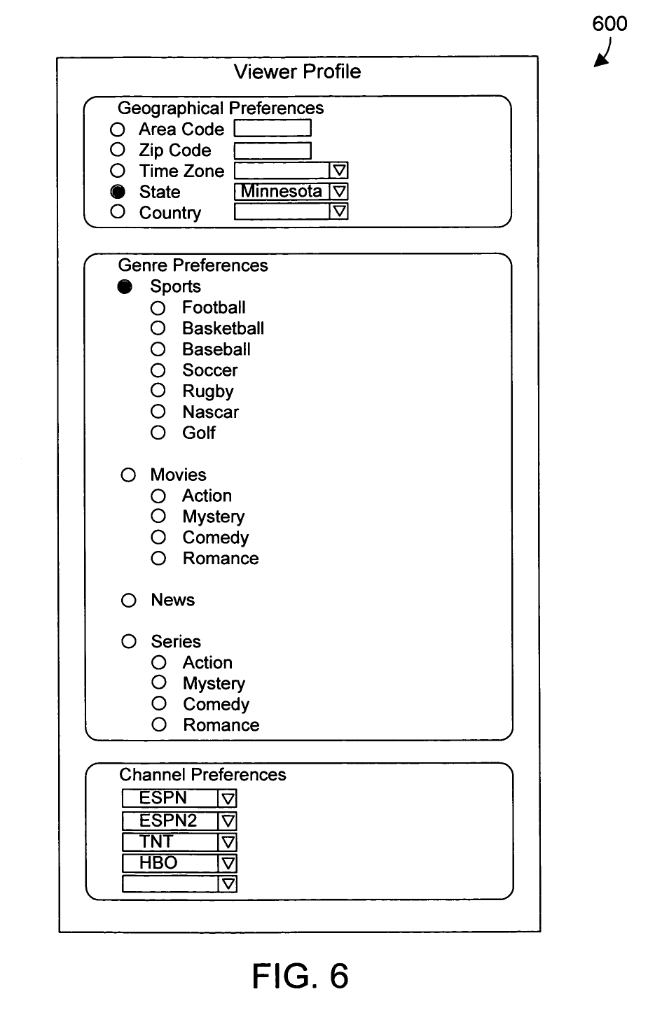

The definition of a viewer profile in step 410 may include many different parameters. Examples of some of those parameters are shown in method 410 in FIG. 5, which is one suitable implementation for step 410 in FIG. 4. The viewer may define geographical preferences in the viewer profile (step 510). The viewer may define genre preferences in the viewer profile (step 520). The viewer may also define channel preferences in the viewer profile (step 530). Of course, the viewer could also define or select other information in the viewer profile besides those shown in FIG. 5. Note also that method 410 may include any of the steps shown in FIG. 5 without necessarily performing the other steps shown. In addition, all or part of the viewer profile could be determined dynamically by the receiver monitoring the viewing habits of the viewer. Thus, if the viewer watches a lot of different sports programs, the system could set the viewer profile so the Sports selection were automatically selected (as shown in FIG. 6) by the receiver as a result of the receiver monitoring the viewer's viewing habits. In this case, while the viewer does not explicitly define the viewer profile, the viewer implicitly defines the viewer profile by simply changing channels and allowing the receiver to monitor the changes and automatically set the viewer profile accordingly.

Referring to FIG. 6, a sample user interface window 600 is shown that allows a user to define a viewer profile (222 in FIG. 2). In this specific example, the user may select from geographical preferences, genre preferences, or channel preferences. In the geographical preferences, the viewer may specify a geographical region of interest in any suitable way. Five suitable ways are shown in FIG. 6, and include: area code, zip code, time zone, state, and country. Note that the geographical region of interest may also include a default selection (not shown in FIG. 6) that may be selected by the user and defined by the provider 102. The ability to select a geographical preference provides interesting possibilities. In most cases, the viewer will select a geographical preference for an area where the viewer lives. Note, however, that this need not necessarily be the case. For example, let's assume that a lifelong Minnesota resident retires in Florida.

That person could specify the state of Minnesota as the geographical region of interest even though they reside in Florida so they can weight the viewership information that relates to Minnesota residents more heavily than for the local residents.

The genre preferences in the user interface window 600 in FIG. 6 allow the user to select different genres of programs. The genres shown in FIG. 6 include: sports, movies, news and series. Note that the genre preferences may be defined at different levels. For example, the user may select “Sports” as shown in FIG. 6, which will provide appropriate weighting of all sport programs in the viewership information. In the alternative, the user may select a specific sport or sports as being of more interest than others by clicking on their radio buttons in the Genre Preferences. Thus, if a viewer is a football and Nascar fan, the viewer may select these preferences without selecting all sporting events. In similar fashion, the user may select the “Movies” category, or may select one or more genres of movies. The user may select the “News” category. The user may also select the “Series” category, or may select one or more genres of series. Of course, other genres and categories could also be presented to the user for selection within the scope of the preferred embodiments.

The channel preferences in the user interface window 600 in FIG. 6 allows selecting several different channels as favorites, which will allow weighting the viewership information for other users on those channels more heavily than for other channels. As shown in FIG. 6, ESPN, ESPN2, TNT and HBO are selected as favorite channels in the Channel Preferences section of the user interface window.

While geographical preferences, genre preferences, and channel preferences are shown in the user interface window 600 of FIG. 6, the preferred embodiments expressly extend to any suitable information that may be included in a viewer profile (222 in FIG. 2). The viewer profile 222 provides information concerning a viewer's tastes and preferences that allow better filtering, weighting and processing the viewership information received from the system provider.

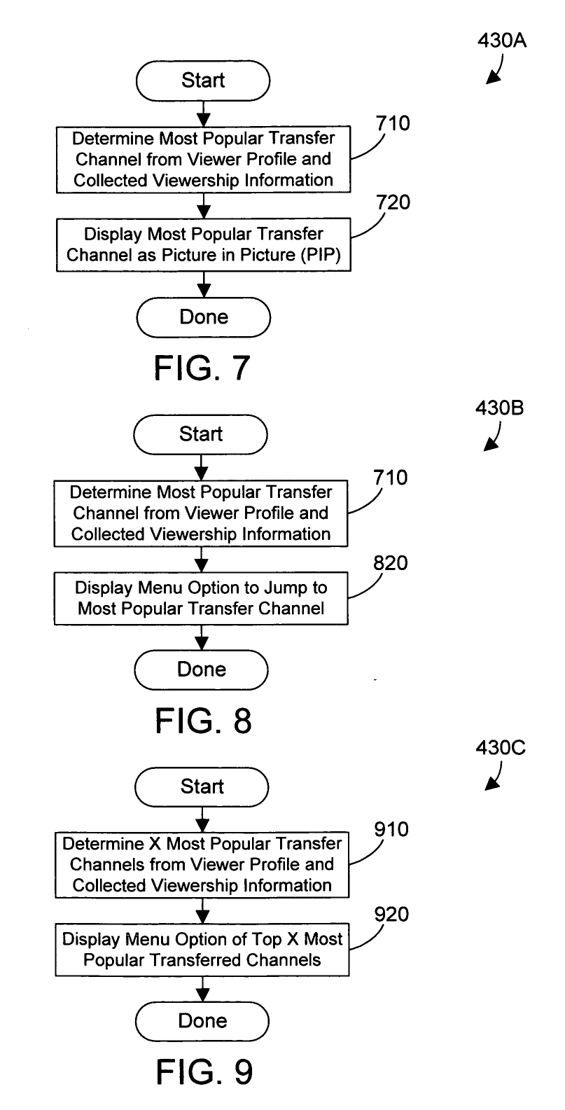

There are many different actions that may be taken in step 430 in FIG. 4 as a result of processing the viewership information with respect to the viewer preferences. The preferred embodiments expressly extend to automatically performing any suitable action as a result of processing the viewership information and viewer preferences. Several examples of suitable actions are disclosed in FIGS. 7-12 and are discussed in detail below.

A first suitable implementation of step 430 in FIG. 4 is shown as method 430A in FIG. 7. The most popular transfer channel may be determined from the viewer profile and from the collected viewership information (step 710). The most popular transfer channel may then be displayed as picture-in-picture (PIP) (step 720), which is a small display box that is placed on the television display so the viewer may view two programs simultaneously. In this manner, a PIP window can automatically appear to show the user the channel where most of the viewers that satisfy their viewer profile have gone next.

A second suitable implementation of step 430 in FIG. 4 is shown as method 430B in FIG. 8. The most popular transfer channel may be determined from the viewer profile and from the collected viewership information (step 710). A menu option may then be displayed to jump to the most popular transfer channel (step 820). In this manner the user may easily jump to the most popular transfer channel without being interrupted by a PIP window. In the alternative, the remote control for the receiver 180 could include a button “Jump to Most Popular” that would allow the receiver to switch at any time to the most popular transfer program.

A third suitable implementation of step 430 in FIG. 4 is shown as method 430C in FIG. 9. The top X most popular transfer channels may be determined from the viewer profile and from the collected viewership information (step 910). A display menu of the top X most popular transfer channels may then be displayed to the viewer (step 920).

While method 430B presents the single most popular transfer channel, method 430C allows selecting from several most popular transfer channels.

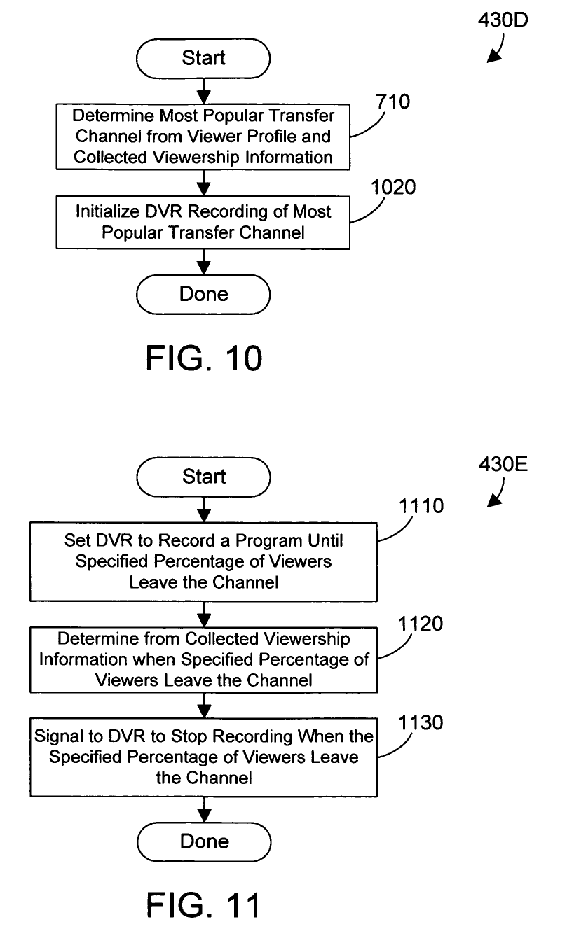

A fourth suitable implementation of step 430 in FIG. 4 is shown as method 430D in FIG. 10. The most popular transfer channel may be determined from the viewer profile and from the collected viewership information (step 710). The recording of the most popular transfer channel may then be initialized (step 1020). This allows the program on the most popular transfer channel to be recorded automatically, even if the viewer continues to view a different channel. By automatically initializing recording of the most popular transfer channel, the receiver automatically records a program that the viewer may find of interest for viewing at a later time.

A fifth suitable implementation of step 430 in FIG. 4 is shown as method 430E in FIG. 11. We assume a DVR is set to record a program until a specified percentage of viewers leave the channel (step 1110). The viewership information is then analyzed to determine when the specified percentage of viewers leave the channel (step 1120) after the expected end time is reached. The DVR is then signaled by the receiver to stop recording when the specified percentage of viewers leave the channel (step 1130). The function in method 430E is especially useful for recording live events, such as football games. In the prior art, setting a DVR to record a football game will cause the DVR to stop recording at the time the football game is expected to end. However, sometimes a football game may go longer than expected, especially if the game goes into overtime. It is reasonable to assume that the game is still going on if some specified percentage of viewers are still watching, even though the expected time for the end of the game arrives. Method 430E allows the DVR to continue recording until the specified percentage of viewers leave the channel, thereby enhancing the likelihood that all of the game will be recorded.

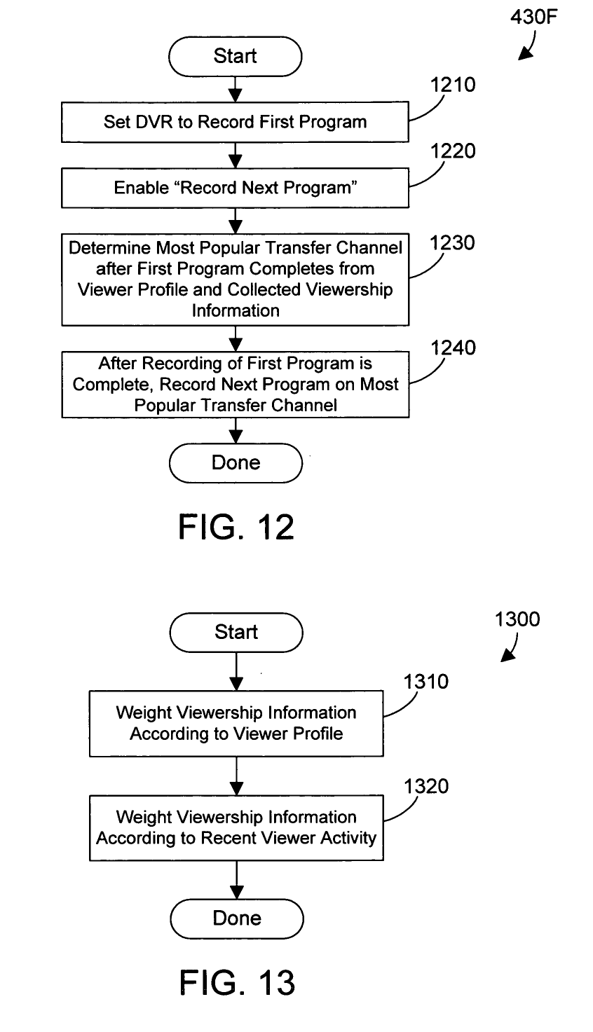

A sixth suitable implementation of step 430 in FIG. 4 is shown as method 430F in FIG. 12. We assume a DVR is set to record a first program (step 1210). A “record next program” feature is then enabled, either on the receiver or on the DVR (step 1220). When the first program completes, the receiver determines the most popular transfer channel from the viewer profile and the collected viewership information (step 1230), and the next program on the most popular transfer channel can be automatically recorded (step 1240). Method 430F allows recording a first program, with second and other programs recorded in succession according to the most popular transfer channel for the next program. This allows recording a string of programs according to the viewership information and viewer profile by only specifying the first program to record. The result is automatically storing many programs that may be of interest to the viewer for later viewing.

Referring to FIG. 13, a method 1300 shows two possible ways of weighting the viewership information from the provider. The first weights the viewership information according to the viewer profile (step 1310). The viewer profile is created in order to provide appropriate weighting of the viewership information received from the provider.

A sports fanatic may not care about the viewing habits of those that watch a romance movie channel. For this reason, the viewer profile allows appropriate weighting of the viewership results according to the user's specified preferences in the viewer profile. Another way to weight the viewership information from the provider is according to the viewer's recent activity (step 1320). This does not mean that the viewer profile is ignored. To the contrary, the viewer profile is still used, but greater weight can be given to viewership data that show a similar pattern of watching as exhibited by the user. For example, if the viewer is watching a football game, and is changing channels during the commercials to view a rugby game, additional weight will be given to the viewership information that best matches the actions by the viewer.

Note that it is possible within the scope of the preferred embodiments to define multiple viewer profiles on the same television receiver that correspond to different users, or that correspond, for example, to different moods of the same user. The user can select from a menu one or more viewer profiles, and the automatic actions will then be taken based on the selected viewer profile and the viewership information from the provider. In the alternative, the receiver could automatically detect the viewer and select the appropriate viewer profile. Note also that any recordings could also be filtered or presented based on the viewer profile.

The preferred embodiments provide a way for a television receiver to automatically take action according to viewership information received from the provider and according to a selected viewer profile defined by a user of the television receiver.

The receiver of the preferred embodiments provides a significantly enhanced television viewing experience by providing automatic actions according to the viewer profile and the viewership information, which indicates what other viewers are viewing.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A television receiver comprising:
at least one processor;
a memory coupled to the at least one processor;
a viewership collection mechanism residing in the memory that receives aggregate viewership information from a program provider coupled to the television receiver;
a viewer profile mechanism residing in the memory that allows a user of the television receiver to define a viewer profile; and
a viewership action mechanism residing in the memory that processes the viewership information and the viewer profile, and in response thereto, performs at least one action based on the processed viewership information and the viewer profile.

2. The television receiver of claim 1 wherein the viewer profile includes at least one of: geographical preferences, genre preferences and channel preferences.

3. The television receiver of claim 1 wherein the at least one action comprises the steps of:
determining a most popular transfer channel; and
performing at least one of the steps of:
displaying the most popular transfer channel as picture-in-picture (PIP);
displaying a menu option to jump to the most popular transfer channel; and
initializing recording of the most popular transfer channel.

4. The television receiver of claim 1 wherein the at least one action comprises the steps of:
determining a plurality of most popular transfer channels; and
displaying a menu comprising the plurality of most popular transfer channels.

5. The television receiver of claim 1 wherein the at least one action comprises the steps of:
determining a most popular transfer channel for a next program; and
initializing recording of the most popular transfer channel for a next program.

6. The television receiver of claim 1 wherein the at least one action comprises the step of signaling to stop recording when the viewership information indicates a specified percentage of viewers have left a current channel.

7. A method for a television receiver to automatically perform at least one action, the method comprising the steps of:
(A) presenting a user interface to a viewer thereby allowing the viewer to define a viewer profile;
(B) receiving aggregate viewership information from a program provider;
(C) processing the aggregate viewership information in view of the viewer profile; and
(D) automatically performing at least one action based on the processed viewership information and the viewer profile.

8. The method of claim 8 wherein step (A) comprises the step of allowing a user to select at least one of: geographical preferences, genre preferences and channel preferences.

9. The method of claim 8 wherein step (C) comprises the step of determining a most popular transfer channel, and wherein step (D) comprises at least one of the steps of:
displaying the most popular transfer channel as picture-in-picture (PIP);
displaying a menu option to jump to the most popular transfer channel; and
initializing recording of the most popular transfer channel.

10. The method of claim 8 wherein step (C) comprises the step of determining a plurality of most popular transfer channels, and wherein step (D) comprises the step of displaying a menu comprising the plurality of most popular transfer channels.

11. The method of claim 8 wherein step (C) comprises the step of determining a most popular transfer channel for a next program, and wherein step (D) comprises the step of initializing recording of the most popular transfer channel for a next program.

12. The method of claim 8 wherein step (D) comprises the step of signaling to stop recording when the viewership information indicates a specified percentage of viewers have left a current channel.

13. A computer-readable program product comprising:
(A) a viewership collection mechanism that receives aggregate viewership information from a program provider coupled to the television receiver;
(B) a viewer profile mechanism that allows a user to define a viewer profile;
(C) a viewership action mechanism that processes the viewership information and the viewer profile, and in response thereto, performs at least one action based on the processed viewership information and the viewer profile; and
(D) computer-readable signal bearing media bearing (A), (B) and (C).

14. The program product of claim 15 wherein the computer-readable signal bearing media comprises recordable media.

15. The program product of claim 15 wherein the computer-readable signal bearing media comprises transmission media.

16. The program product of claim 15 wherein the viewer profile includes at least one of: geographical preferences, genre preferences and channel preferences.

17. The program product of claim 15 wherein the at least one action comprises the steps of:
determining a most popular transfer channel; and
performing at least one of the steps of:
displaying the most popular transfer channel as picture-in-picture (PIP);
displaying a menu option to jump to the most popular transfer channel; and
initializing recording of the most popular transfer channel.

18. The program product of claim 15 wherein the at least one action comprises the steps of:
determining a plurality of most popular transfer channels; and
displaying a menu comprising the plurality of most popular transfer channels.

19. The program product of claim 15 wherein the at least one action comprises the steps of:
determining a most popular transfer channel for a next program; and
initializing recording of the most popular transfer channel for a next program.

20. The program product of claim 15 wherein the at least one action comprises the step of signaling to stop recording when the viewership information indicates a specified percentage of viewers have left a current channel.

21. A television system comprising:
(A) a television provider system that collects viewership information from a plurality of subscribers; and
(B) a plurality of television receivers coupled to the television provider system, each television receiver comprising:
a viewership collection mechanism that receives the viewership information from the television provider system;
a viewer profile mechanism that allows a user of the television receiver to define a viewer profile; and
a viewership action mechanism that processes the viewership information and the viewer profile, and in response thereto, performs at least one action based on the processed viewership information and the viewer profile.
